(19) United States
(12) Patent Application Publication
(10) Pub. No.: US 2012/0079878 A1
(43) Pub. Date: Apr. 5, 2012

(54) COMPRESSION SENSOR GASKET ASSEMBLY AND METHOD OF SERVICING A COMBUSTION PRESSURE SENSOR WITHIN A GASKET ASSEMBLY

(76) Inventors: David M. Toth, Brighton, MI (US); Brent Sedlar, Ann Arbor, MI (US)

(21) Appl. No.: 13/251,346

(22) Filed: Oct. 3, 2011

Related U.S. Application Data
(60) Provisional application No. 61/388,834, filed on Oct. 1, 2010.
(60) Provisional application No. 61/418,010, filed on Nov. 30, 2010.

(51) Int. Cl. G01M 15/08; B23P 6/00

(52) U.S. Cl. 73/114.18; 29/402.03

(57) ABSTRACT

A compression sensor gasket assembly includes a gasket body having opposite substantially planar sealing surfaces configured for sealing abutment with an engine block and a cylinder head. The gasket body has at least one through opening configured to register with a cylinder bore and a passage extends from an outer periphery of the gasket body between the opposite sealing surfaces. The gasket assembly includes a mounting flange fixed to the gasket body. The mounting flange extends outwardly from one of the substantially planar sealing surfaces. A pressure sensor assembly extends through the passage, and a mounting member is releasably fixed to the mounting flange to operably fix the pressure sensor assembly to the gasket body. The pressure sensor assembly is readily accessible, such that during service the pressure sensor assembly can be removed and serviced without having to remove the cylinder head from the engine block.

### CROSS-REFERENCE TO RELATED APPLICATIONS

This application claims the benefit of U.S. Provisional Application Ser. No. 61/388,834, filed Oct. 1, 2010, and the benefit of U.S. Provisional Application Ser. No. 61/418,010, filed Nov. 30, 2010, which are incorporated herein by reference in their entirety.

### BACKGROUND OF THE INVENTION

1. Technical Field

This invention relates generally to internal combustion engines, and more particularly to compression gaskets for forming a seal about a chamber within an internal combustion engine.

2. Related Art

Internal combustion engines have chambers in which high pressures are generated. Generally, a pair of members mate with one another to form the chamber or chambers, such as a cylinder head and engine block, for example, with a gasket being received between the members to provide a gas/fluid tight seal. In addition to the gasket, it is known to provide a separate pressure sensor to indicate the pressure within the chamber. Having separate gasket and sensor components typically comes at an increased cost, both in manufacture and assembly.

Some attempts have been made to provide a single component gasket and compression sensor. However, these attempts have not been met with great success due to an increased cost associated therewith, particularly during service. The known gasket/sensor assemblies must be replaced in their entirety during service, thereby leading to the increased cost of having to replace both the gasket and the sensor. Further, the known gasket/sensor assemblies require removal of the cylinder head from the engine block to gain access to the gasket assembly components, which is labor intensive and costly. Accordingly, what is needed is a gasket and sensor assembly that can provide a reliable seal between mating members, provide an accurate indication of the pressure within the combustion chamber, provide a gasket with its thickness minimally increased due to pressure sensor integration, provide an ability to route the sensor about passages extending between the cylinder head and the engine block, have separately replaceable components in service, allow replacement of electronics without having to disassemble the cylinder head from the engine block, and be provided in an economical fashion, both in manufacture and in use.

### SUMMARY OF THE INVENTION

A compression sensor gasket assembly includes a gasket body having opposite substantially planar sealing surfaces configured for sealing abutment with an engine block and a cylinder head. The gasket body has at least one through opening configured to register with a cylinder bore in the engine block and a passage extending from an outer periphery of the gasket body between the opposite sealing surfaces into the through opening. The gasket assembly further includes a mounting flange fixed to the gasket body. The mounting flange extends outwardly from one of the substantially planar sealing surfaces. A pressure sensor assembly extends through the passage to indicate the pressure within the cylinder bore, and a mounting member is releasably fixed to the mounting flange to operably fix the pressure sensor assembly to the gasket body. With the mounting member being fixed to the mounting flange in spaced relation from one of the sealing surfaces, the pressure sensor assembly is readily accessible, such that during service the pressure sensor assembly can be removed and serviced without having to remove the cylinder head from the engine block.

In accordance with another aspect of the invention, the mounting member and pressure sensor assembly are maintained below a planar sealing surface of a cylinder head.

In accordance with another aspect of the invention, the mounting flange is formed as a monolithic piece of material with the gasket body.

In accordance with another aspect of the invention, the mounting flange is formed from a separate piece of material from the gasket body and subsequently fixed thereto.

In accordance with another aspect of the invention, the pressure sensor assembly is biased into sealed abutment with a surface of the gasket body by a spring member.

In accordance with another aspect of the invention, the spring member is sandwiched between the mounting flange and the mounting member.

In accordance with another aspect of the invention, a method of servicing a pressure sensor assembly at least partially sandwiched between a cylinder head and cylinder block of an internal combustion engine is provided. The method includes, while leaving the cylinder head attached to the engine block, removing at least a portion of the pressure sensor assembly from between the cylinder head and the cylinder block and inserting a replacement portion of the pressure sensor assembly therebetween.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a top perspective view of a portion of a gasket body assembly constructed in accordance with another presently preferred embodiment of the invention;

FIG. 2 is a bottom perspective view of the gasket body assembly of FIG. 1;

FIG. 3 is a top perspective view of a portion of a gasket body assembly constructed in accordance with yet another presently preferred embodiment of the invention;

FIG. 4 is a bottom perspective view of the gasket body assembly of FIG. 4;

FIG. 5 is a top perspective view of a portion of a gasket body assembly constructed in accordance with yet another presently preferred embodiment of the invention;

FIG. 6 is a bottom perspective view of the gasket body assembly of FIG. 5;

FIG. 7 is a top perspective view of a portion of a gasket body assembly constructed in accordance with yet another presently preferred embodiment of the invention;

FIG. 8A is cross-sectional view of the gasket body assembly of FIG. 7 showing a spring member imparting a bias on a pressure sensor assembly of the gasket body assembly;

FIG. 8B is a perspective view of the spring member of FIG. 8A;

FIGS. 9A and 9B are a top schematic views of a disassembled and assembled gasket body assembly, respectively, constructed in accordance with yet another presently preferred embodiment of the invention;

FIG. 10 is a front view of a portion of a gasket body assembly constructed in accordance with another aspect of the invention; and

FIG. 11 is a cross-sectional view taken generally along the line 11-11 of the gasket body assembly of FIG. 10.

### DETAILED DESCRIPTION OF PRESENTLY PREFERRED EMBODIMENTS

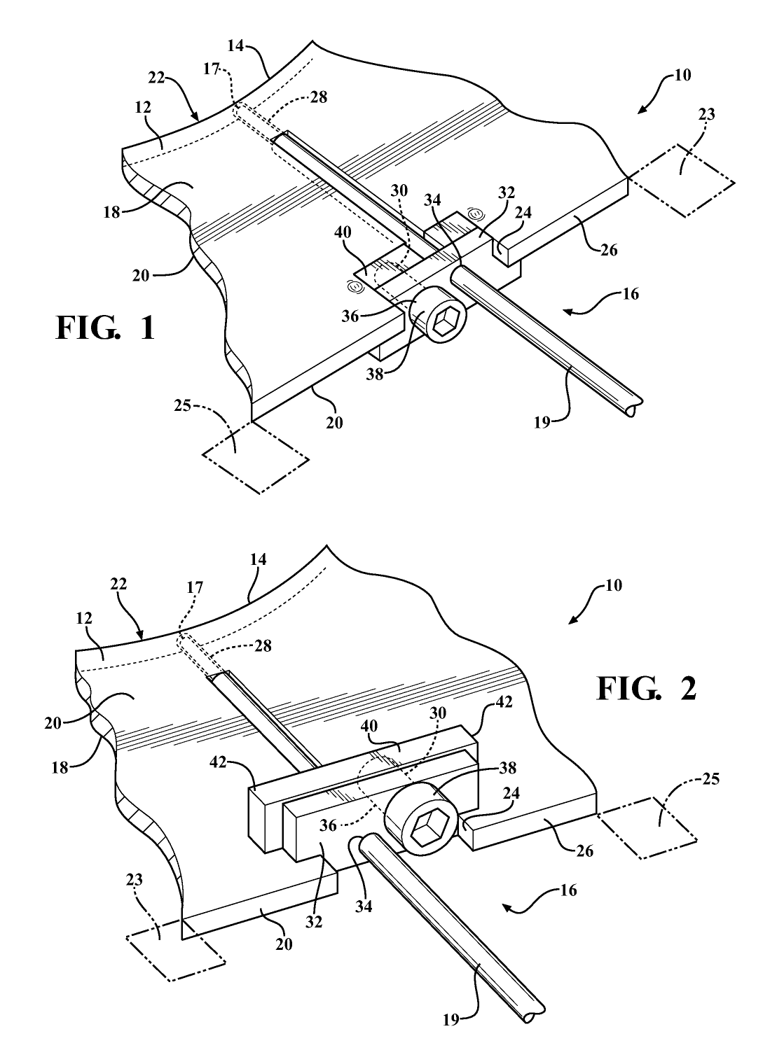

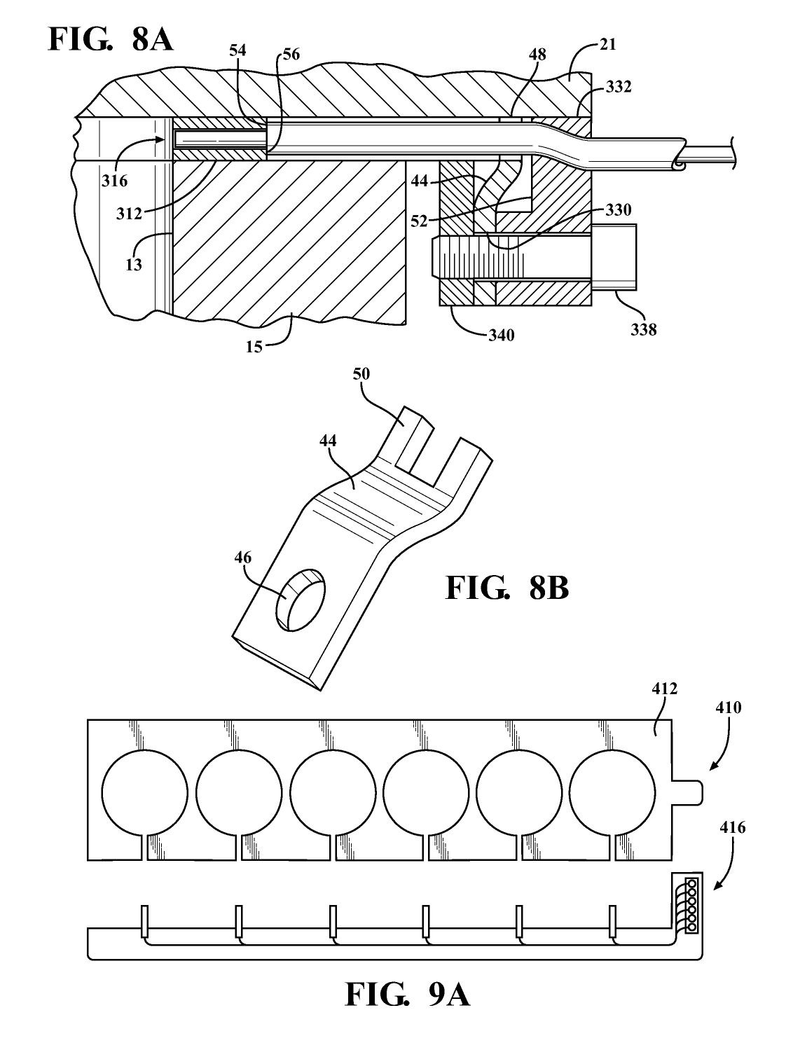

Referring in more detail to the drawings, FIG. 1 illustrates a portion of compression sensor gasket assembly, referred to hereafter as gasket assembly 10, constructed in accordance with one presently preferred embodiment of the invention. The gasket assembly 10 has a metal distance layer, referred to hereafter as gasket body 12, with one or more through openings, also referred to as through passages 14, for the passage of fluid or gas therethrough, such as an opening configured to register in axial alignment with a cylinder bore 13 in an engine block 15 (FIG. 8), for example. The gasket assembly 10 has a pressure sensor assembly 16 at least partially releasably attached in sealed engagement with the gasket body 12. The pressure sensor assembly 16 includes a pressure sensor 17 that is configured to sense pressure within the through passage 14 and within the cylinder bore 13 being sealed and electronic members 19, including optical or otherwise, configured in electrical communication with the pressure sensor 17. In service, at least a portion of the pressure sensor assembly 16, whether it be the pressure sensor 17 and/or the electronic members 19, can be removed from the gasket body 12 and replaced, as necessary, without having to remove a cylinder head 21 (FIG. 8) from the engine block 13. The pressure sensor assembly 16, upon being attached to the gasket body 12, does not extend above an upper plane 23 of the gasket body 12, and thus, the pressure sensor assembly 16 does not interfere with the cylinder head 21, even when the cylinder head 21 overhangs the engine block 13.

The gasket body 12 can be provided as a monolithic piece of material having a substantially flat body, having a minimal thickness extending between opposite substantially planar sides providing upper cylinder head and lower engine block sealing surfaces, also referred to as upper and lower sealing surfaces 18, 20, respectively, configured for respective sealed engagement directly with the cylinder head 18 and engine block 13 or one or more functional layers fabricated from a resilient metal (not shown), such as spring steel, for example, having sealing beads, including half and/or full sealing beads, as desired. The through passages 14 have an inner surface or periphery 22 configured to register with the passage being sealed. To facilitate attaching the pressure sensor assembly 16 to the gasket body 12, the gasket body 12 has a plurality of through slots 24 extending through the opposite sides 18, 20 from an outer periphery 26 (the outer most portion of the gasket body 12) toward a respective through passage 14. The through slots 24 can be stamped, milled or otherwise machined through the sealing surfaces 18, 20. In addition, an enclosed tubular portion, represented as a machined portion, such as in a drilling operation, for example, and thus, also referred to as drilled portion 28, extends from the respective through slot 24 radially inwardly to the inner periphery 22. The drilled portion 28 can be sized for a close fit, such as line-to-line, with a portion of the pressure sensor 17, or it can be enlarged for receipt of an adaptor sleeve, seal, heat shield, or other type of fitting.

To facilitate attaching the pressure sensor assemblies 16 to the gasket body 12, a sensor mounting member 32 is provided for receipt within each through slot 24. The sensor mounting member 32 has a through opening 34 sized for receipt of the pressure sensor 17. Further, the sensor mounting member 32 has at least one fastener passage 36 configured for receipt of a fastener 38.

To further facilitate attaching the pressure sensor assemblies 16 to the gasket body 12, the gasket body 12 has a fastening member, also referred to as mounting flange or fastener plate 40. The fastener plate 40 is fixed to extend outwardly from the gasket body lower sealing surface 20. The fastener plate 40 has at least one fastener opening 30 formed therein, wherein the fastener opening 30 is configured for alignment with the fastener passage 36 in the mounting member 32 upon fixing the fastener plate 40 to the gasket body 12. The fastener plate 40 is shown extending flush or substantially flush with the gasket body upper sealing surface 18 and depending downwardly beyond the lower sealing surface 20. The fastener plate 40, as shown in FIG. 2, has flanges 42 extending laterally away from one another in abutment with the lower sealing surface 20. An upper surface of the flanges 42 is fixed to the lower sealing surface 20, such as via an adhesive or weld joint, e.g. laser welding, for example. Accordingly, during assembly, a fastener 38 is extended through a fastener passage 36 in a sensor mounting member 32 and then threaded in the fastener opening 30 of the fastener plate 40. As such, the fastener 38, being below the plane 25 of the lower sealing surface 20, can have an enlarged head without extending above the upper plane 23 of the upper sealing surface 18.

During assembly, each pressure sensor 17 is received in the drilled portion 28 adjacent the inner periphery 22, while the wires 19 are routed radially outwardly for electrical connection to a PCB or plurality of PCB's (not shown). Upon fastening the sensor mounting member 32 via threaded fasteners 38 to the mounting member 32, the pressure sensor 17 is fixed in its sensing position relative to the inner periphery 22 of the through opening 14. Further, the sensor mounting member 32 is configured to exert a bias on the pressure sensor 17 to maintain the pressure sensor 17 in its intended sensing position. As desired, such as during service, the fasteners 38 can be removed without removing the cylinder head 21 from the engine block 13 for removal of the respective pressure sensor assembly 16.

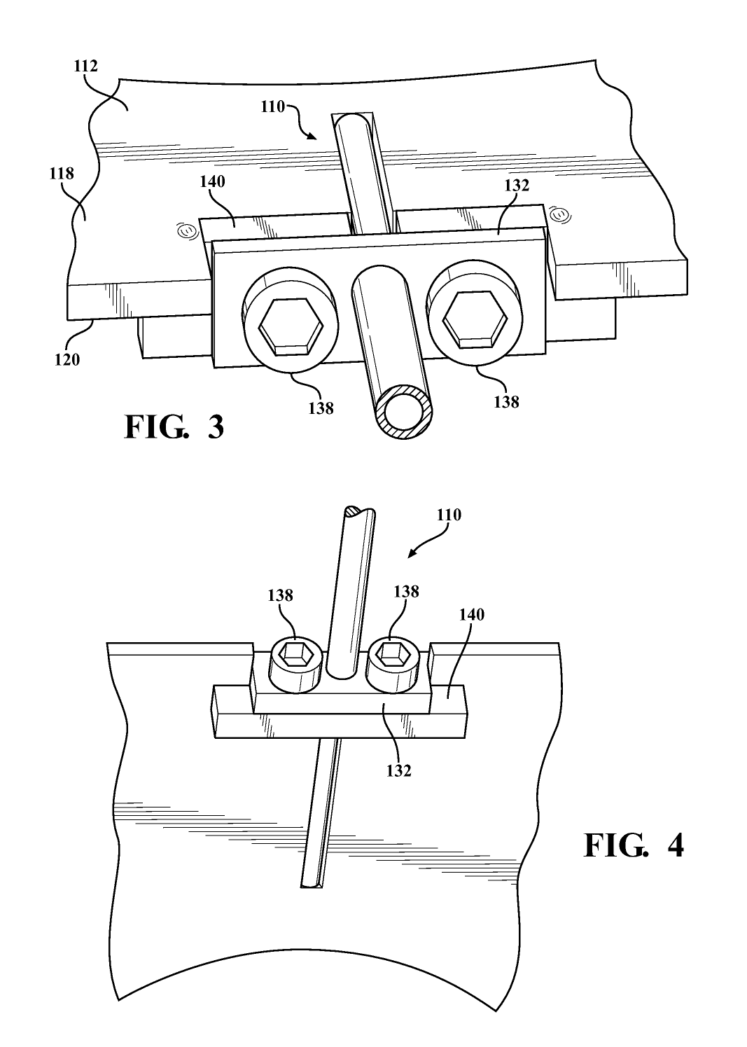

In FIGS. 3 and 4, a compression sensor gasket assembly 110 is shown constructed in accordance with another aspect of the invention, wherein the same reference numerals, offset by a factor of 100, are used to identify like features discussed above. The gasket assembly 110 is similar to the gasket assembly 10, having a gasket body 112 with opposite substantially planar cylinder head and engine block sealing surfaces 118, 120. However, rather than having a single fastener opening, a pair of fastener openings are provided in a fastener plate 140 and in a mounting member 132 on laterally opposite sides of a pressure sensor assembly 116. As such, the loads applied via fasteners 138 are balanced across the pressure sensor assembly 116.

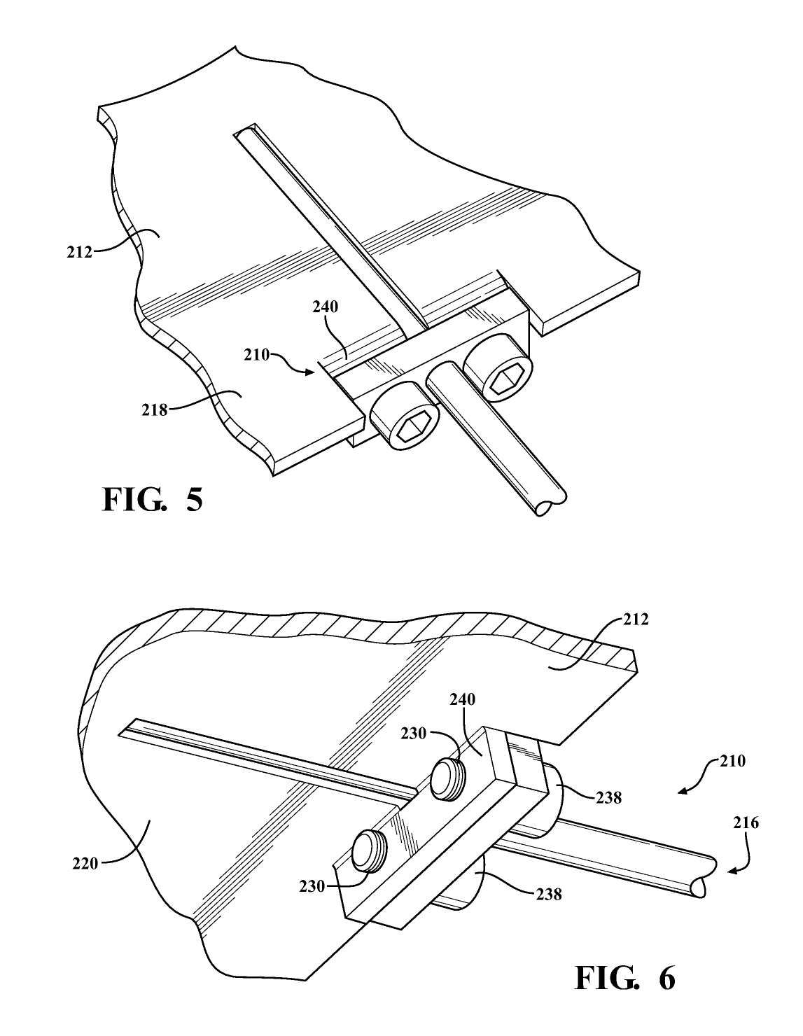

In FIGS. 5 and 6, a compression sensor gasket assembly 210 is shown constructed in accordance with another aspect of the invention, wherein the same reference numerals, offset by a factor of 200, are used to identify like features discussed above. The gasket assembly 210 is similar to the gasket assembly 110, having a gasket body 212 with opposite planar cylinder head and engine block sealing surfaces 318, 320 and a pressure sensor assembly 216 releasable fastened thereto. However, rather than having a fastener plate provided as a separate piece of material from the gasket body 212, as with the previously discussed gasket assemblies 10, 110, a fastener plate 240 is formed from the material of the gasket body 212 as a monolithic piece of material with the gasket body 212. Thus, the fastener plate 240 is cut or pressed and folded to form the fastener plate 240, such as in a stamping operation, for example. Otherwise, the fastener plate 240 is structured similarly to the gasket plate 240, though not having laterally extending flanges, thus including at least one and shown as a pair of fastener openings 230 for threaded receipt of a corresponding number of fasteners 238. It should be recognized that the fastener plate 240 could be formed having a single fastener opening, such as shown and described relative to the fastener plate 40.

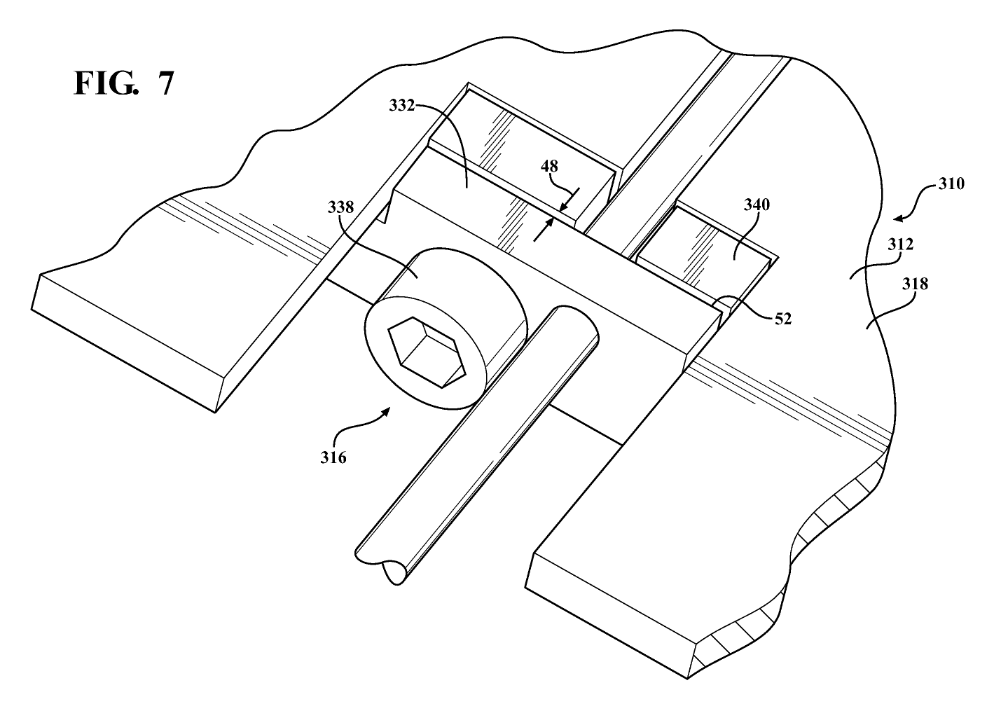

In FIGS. 7 and 8A, a compression sensor gasket assembly 310 is shown constructed in accordance with another aspect of the invention, wherein the same reference numerals, offset by a factor of 300, are used to identify like features discussed above. The gasket assembly 310 is similar to the gasket assembly 10, having a gasket body 312 with opposite planar or substantially planar sealing surfaces 318, 320 and a fastener plate 340 extending outwardly from the lower sealing surface 320. The fastener plate 340 is shown as being constructed from a separate piece of material from the gasket body 312, though it could be constructed as a monolithic piece of material with the gasket body 312, as shown and discussed with regard to FIGS. 5 and 6. Further, the fastener plate 340 has at least one fastener opening 330 formed for threaded receipt of a corresponding fastener 338. A difference in this embodiment is with regard to a spring member 44 (FIGS. 8A and 8B) that is disposed between the fastener plate 340 and a sensor mounting member 332. Rather than the sensor mounting member 332 exerting a bias compressive load directly on the sensor assembly 316 and on the fastener plate 340, the spring member 44 exerts a spring bias on the pressure sensor assembly 316, and thus, acts to maintain the desired load on the pressure assembly 316. The spring member 44 has an opening 46 configured as a through opening for the fastener 338, wherein the portion of the spring member 44 sandwiched between a lower most portion of the sensor mounting member 332 and the fastener plate 340 is compressed and fixed in place via the compressive load applied by the fastener 338. Meanwhile, an upper portion of the spring member 44, shown as having a bifurcated end 50 for disposal about a portion of the pressure sensor assembly 316, is received in a gap 48 between an upper portion of the sensor mounting member 332 and the gasket body 312. The gap 48 is provided by a recessed surface or step 52 in the sensor mounting member 332 wherein the gap 48 is sized to prevent the sensor mounting member 332 from abutting and compressing the spring member 44 upon tightening the fastener 338. As such, it is solely the spring force imparted by the spring member 44 on the pressure sensor assembly 316 that applies an axial preload on the pressure sensor assembly 316. Accordingly, the preload applied to the pressure sensor assembly 316 bringing a sealing surface 54 of the pressure sensor assembly 316 into sealed abutment with a sealing surface 56 of the gasket body 312 is precisely and solely controlled by the spring force of the spring member 44. It should be recognized that the preload applied by the spring member 44 can be precisely controlled, such as by altering the configuration and material properties of the spring member 44, for example.

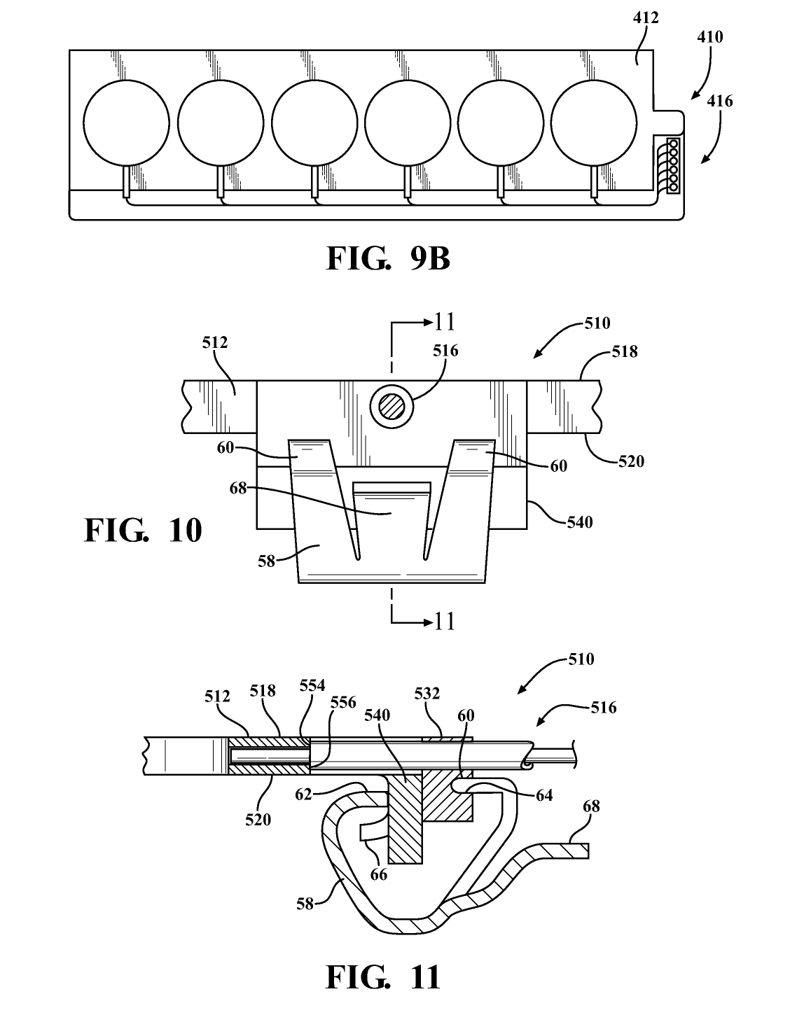

As shown in FIGS. 9A and 9B, a compression sensor gasket assembly 410 is shown constructed in accordance with another aspect of the invention, wherein the same reference numerals, offset by a factor of 400, are used to identify like features discussed above. The gasket assembly 410, rather than having individual pressure sensor assemblies, has a unitized plurality of pressure sensor assemblies 416 configured for releasable attachment to a gasket body 412. It should be recognized that each individual pressure sensor assembly 416 can be configured in accordance with any of the embodiments describe above and shown in the FIGS. 1-8.

In FIGS. 10 and 11, a compression sensor gasket assembly 510 is shown constructed in accordance with another aspect of the invention, wherein the same reference numerals, offset by a factor of 500, are used to identify like features discussed above. The gasket assembly 510 is similar to the previously discussed gasket assemblies 110, 210, 310 or 410 (spring member not shown, but can be incorporated as discussed above) having a gasket body 512 with a pressure sensor assembly 516 releasable attached thereto. The gasket body 512 has opposite planar sealing surfaces 518, 520 and a fastener plate 540 extending outwardly from the lower sealing surface 520. However, rather than a threaded fastener extending through an opening in a sensor mounting member 532 and then being threaded in a fastener opening of the fastener plate 540 to fasten the pressure sensor assembly 516 in place, a clip member, shown here as a spring clip 58 is used to releasably attach the pressure sensor assembly 516 to the gasket body 512. The spring clip 58 is shown, by way of example and without limitation, as having a pair of bifurcated fingers 60 configured on one side for engagement with the sensor mounting member 532 and another finger 62 configured opposite the fingers 60 for engagement with the fastener plate 540. The sensor mounting member 532 can be configured having a catch, such as a protrusion, or as shown, a recessed notch or groove 64, configured for selectively releasable locked receipt of the fingers 60, while the fastener plate 540 can be provided having a catch, shown configured as a stamped or otherwise folded groove or lip 66 for selectively releasable locked receipt of a finger 68. Upon the fingers 60, 62 being disposed or snapped into their respective catches 58, 60, the sensor mounting member 532 is biased under a spring force into sealed abutment, such as via mating conical features, as discussed above, with the gasket body 512.

To facilitate disassembling the pressure sensor assembly 516 from the gasket body 512, such as during service, the spring clip 58 is provided with a release lever 68. By depressing the release lever 68, the fingers 60 are able to be more readily removed from their associated catches 64, such that the spring clip 58 is able to be detached from its fastened position without the use of tools. Further, with the spring clip 58 and the pressure sensor assembly 516 both remaining below the upper sealing surface 518 of the gasket body 512, the disassembly can be performed without first having to remove the cylinder head from the engine block. Accordingly, servicing the pressure sensor assemblies, as desired, is simplified and economical.

In accordance with another aspect of the invention, a method of servicing a pressure sensor assembly 16 at least partially sandwiched between a cylinder head 21 and engine block 15 of an internal combustion engine is provided. The method includes, while leaving the cylinder head 21 attached to the engine block 15 in sealed engagement therewith, removing at least a portion of the pressure sensor assembly 16 from between the cylinder head 21 and the engine block 15 by removing the associated fastener, including one or more of those discussed above, and inserting a replacement portion of the pressure sensor assembly 16 therebetween. In particular, regardless of whether the cylinder head 21 overhangs the engine block 15, the pressure sensor assembly 16 is readily accessible beneath a plane 23 of a gasket body 12 and removable without having to first remove the cylinder head 21 from the engine block 15.

Obviously, many modifications and variations of the present invention are possible in light of the above teachings. It is, therefore, to be understood that within the scope of the appended claims, the invention may be practiced otherwise than as specifically described.

What is claimed is:

1. A compression sensor gasket, comprising:
a gasket body having opposite substantially planar engine block and cylinder head sealing surfaces configured for respective sealing abutment with an engine block and a cylinder head, said gasket body including at least one through opening and configured to register with a cylinder bore in the engine block and at least one passage extending from an outer periphery of the gasket body between the opposite sealing surfaces to said through opening;
a mounting flange fixed to the gasket body, said mounting flange extending outwardly from one of the substantially planar sealing surfaces;
a pressure sensor assembly extending through said passage to indicate the pressure within the cylinder bore; and
a mounting member releasably fixed to said mounting flange and operably fixing said pressure sensor assembly to said gasket body.

2. The compression sensor gasket of claim 1 wherein mounting member and pressure sensor assembly are maintained below a planar sealing surface of a cylinder head.

3. The compression sensor gasket of claim 1 wherein said mounting flange is formed as a monolithic, bent piece of material of said gasket body.

4. The compression sensor gasket of claim 1 wherein said mounting flange is formed from a separate piece of material from the gasket body and subsequently fixed thereto.

5. The compression sensor gasket of claim 4 wherein said mounting flange is welded to said gasket body.

6. The compression sensor gasket of claim 5 wherein said mounting flange has a pair of laterally extending flanges underlying said engine block sealing surface, at least one of said flanges being welded to said engine block sealing surface.

7. The compression sensor gasket of claim 1 wherein said pressure sensor assembly is biased into sealed abutment with a surface of the gasket body by a spring member.

8. The compression sensor gasket of claim 7 wherein a portion of said spring member is sandwiched between said mounting flange and said mounting member.

9. The compression sensor gasket of claim 8 wherein a gap is establish between a portion of the said spring member and said mounting member.

10. The compression sensor gasket of claim 1 wherein said mounting flange has at least one fastener opening configured for receipt of a fastener to fix said mounting member to said mounting flange.

11. The compression sensor gasket of claim 10 wherein said fastener opening is beneath said engine block sealing surface.

12. A method of servicing a pressure sensor assembly at least partially sandwiched between a cylinder head and engine block of an internal combustion engine, comprising:
while leaving the cylinder head attached to the engine block, removing at least a portion of the pressure sensor assembly from between the cylinder head and the cylinder block and inserting a replacement portion of the pressure sensor assembly therebetween.

13. The method of claim 13 wherein the removing step includes unfastening a fastener located beneath a seal plane established between the cylinder head and engine block.

14. The method of claim 13 wherein the unfastening includes unclipping a spring clip.
